(19) United States
(12) Patent Application Publication
(10) Pub. No.: US 2008/0021865 A1
(43) Pub. Date: Jan. 24, 2008

(54) METHOD, SYSTEM, AND COMPUTER PROGRAM PRODUCT FOR DYNAMICALLY DETERMINING DATA PLACEMENT

(75) Inventors: Brian L. Corkill, Tucson, AZ (US); Erika M. Dawson, Tucson, AZ (US); Peter S. Sobik, Tucson, AZ (US); Gregory P. Wurth, Sahuarita, AZ (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/458,736

(22) Filed: Jul. 20, 2006

(51) Int. Cl. G06F 17/30

(52) U.S. Cl. 707/2

(57) ABSTRACT

A method, system, and computer program product for determining storage locations for data objects is provided. The method includes providing user-selectable options for assigning storage locations for data objects, which is based upon a minimum threshold size of the data objects defined for a storage group. The options are implemented via a binary large object storage structure (LSS)-enablement indicator. The storage locations are further defined by a view associated with storage groups within an administrative table. Upon receiving a request to store a data object that exceeds the minimum threshold size, the method includes retrieving the selected options from the LSS-enablement indicator. If the LSS-enablement indicator is enabled for a portion of the storage groups, the method includes determining whether a view for the data table of the second storage subsystem for the assigned storage group exists via the administrative table. If the view exists, the data object is stored in the second storage subsystem. Otherwise, the data object is stored in the first storage subsystem.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method to data storage management and, more particularly, to a method, system, and computer program product for providing customized, policy-based data storage management services.

2. Description of Background

Storage management systems provide a means for storing data in a storage system (e.g., disk, optical, and tape). Various policies provided by these storage management systems determine how and where to store the data. For example, IBM's® Data Facility Storage Management Subsystem (DFSMS) includes a data facility product that utilizes Object Access Method (OAM) for storing binary data objects in a storage hierarchy (e.g., use disk before optical). If a disk is used for storing data, policies may be implemented for determining in which database tables the data should be stored. For example, a 4K table may be used to store data less than 4K in size, while objects between 4K and 32K may be stored in a 32K table. Objects larger than 32K may be stored using multiple rows in the 32K table. If a system utilizes data collocation at a storage group level, then each storage group may have its own set of tables (e.g., metadata, 4K data table, 32K data table).

However, storing large objects in the 32K table may result in thousands of rows being used to store a single object. By introducing a third storage subsystem which consists of a binary large object storage subsystem, it is possible to store a single large object within one row. The addition of a third storage subsystem necessitates a change to the existing policy of using object size to determine object location.

The policies used in determining the location for storing data objects are typically pre-established (e.g., based on size) and non-configurable by system users. However, there may be instances when a system user may find it advantageous to control the storage location of various data objects, independent of size.

What is needed, therefore, is a mechanism a system by which a system user, in conjunction with a storage support system, can dynamically direct data into a database management system (DBMS).

### SUMMARY OF THE INVENTION

The shortcomings of the prior art are overcome and additional advantages are provided through an updated method in a storage support system. The method includes providing user-selectable options for assigning storage locations for data objects, which is based upon a minimum threshold size of the data objects defined for a storage group. The options are implemented via a binary large object storage structure (LSS)-enablement indicator. The storage locations are further defined by a view associated with storage groups within an administrative table. Upon receiving a request to store a data object that exceeds the minimum threshold size, the method includes retrieving the selected options from the LSS-enablement indicator. If the LSS-enablement indicator is enabled for a portion of the storage groups, the method includes determining whether a view for the data table of the second storage subsystem for the assigned storage group exists via the administrative table. If the view exists, the data object is stored in the second storage subsystem. Otherwise, the data object is stored in the first storage subsystem.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, through which a user can dynamically specify the storage location for storing data objects of a minimum threshold size (e.g., 32K) and the storage support system can interpret this information to dynamically determine where the data should be placed. The solution farther enables the user to turn the feature on and off across an entire storage system, or across a subset of storage groups.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a computer system on which storage support system services may be implemented;

FIG. 2 illustrates one example of a flow diagram describing a method for implementing the storage support system services;

FIG. 3 illustrates one example of a user interface screen for activating the features provided by the storage support system; and

FIG. 4 illustrates one example of an administrative table utilized by the storage support system services via a database management system.

The detailed description explains the preferred embodiments of the invention, together with advantages and features, by way of example with reference to the drawings.

### DETAILED DESCRIPTION OF THE INVENTION

In accordance with exemplary embodiments, storage support system services are provided. The storage support system services enable system users to specify storage locations for binary data objects that exceed a minimum threshold size. The storage support system services further provide the capability for specifying storage locations for selected storage groups. The solution further enables the user to turn the feature on and off across an entire storage system.

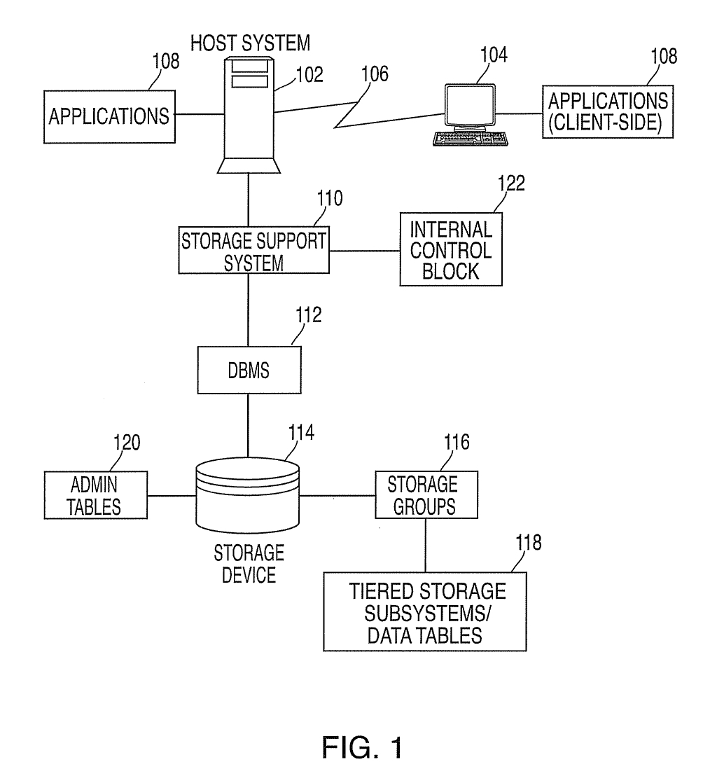

Turning now to FIG. 1, a block diagram of a system upon which the storage support system services may be implemented in exemplary embodiments will now be described. The system of FIG. 1 includes a host system 102 in communication with a workstation 104 over a communication link 106. Host system 102 may be a large mainframe machine such as the IBM Corporation® product called “System/390” or can comprise a workstation such as the IBM Corporation® product called “AS/400” or can comprise an “IBM” machine. Host system 102 implements the storage support system services described herein.

The host system 102 handles sending and receiving information to and from the workstation 104 and can perform associated tasks. The host system 102 executes one or more applications (e.g., operating system (not shown), storage support system 110, database management system 112, etc.) to provide the services described herein. It will be understood that a variety of additional applications (e.g., word processing, spreadsheet, Web-based, etc.) may be implemented by the host system 102.

The host system 102 is in communication with a storage device 114. Storage device 114 may be implemented using memory contained in the host system 102 or it may be a separate physical device. In exemplary embodiments, the storage device 114 is in direct communication with the host system 102 (via, e.g., cabling). However, other network implementations may be utilized. Information stored in the storage device 114 may be retrieved and manipulated via the host system 102. Storage device 114 stores a variety of information for use in implementing the storage support system services. For example, storage device 114 may store various types of information (e.g., data objects requested by one or more applications 108 (e.g., content manager, document manager, record manager, etc.); that is, applications 108 residing on the workstation 104 and/or applications 108 residing on the host system 102). This information may include database tables, files, directories, libraries, etc., or any information typically associated with the operations of a business or organization. As shown in the system of FIG. 1, storage device 114 stores administrative tables 120 and data tables 118 assigned to one of more storage groups 116. In addition, storage support system 110 stores an internal control block 122 that, in turn, stores user selections provided via the storage support system services. The features and functionality of the internal control block is described further herein.

Administrative tables 120 track the data tables stored in storage device 114. When new data tables are created, an entry is created in the administrative tables 120 for the new table. Data tables 118 are grouped by tier, or size, such that a set of data tables of different sizes may be associated with a storage group 116. For example, if host system 102 is implementing IBM'S® DB2 as its database management system 112, then the set of data tables created for each storage group may include a 4K table, a 32K table and an LSS table. LSS tables refer to binary large object (LOB) storage subsystems that provide storage for BLOBs exceeding 32K in size. While the storage system support services reference data tables of these sizes, it will be understood by those skilled in the art that any size grouping of data tables may be implemented in order to realize the advantages of the invention. The sizes presented herein are used as illustrations only and are not to be construed as limiting in scope.

The storage system of FIG. 1 may be implemented as a relational database system that organizes information for more efficient user manipulation. A relational database organizes data values into tables with user-defined interrelationships between the tables. In addition to being organized into tables of related data vales, the data values of the relational database in the illustrated database management system 112 are stored in accordance with storage units defined by a storage device 114 hardware configuration. For example, the IBM Corporation( product called “DB2” relational DBMS stores objects in either a 4 KB or 32 KB data table with a large object potentially requiring thousands of rows to store in the 32 KB data table.

A storage group refers to a logical clustering of data objects. For example, where data is collocated in the storage device 114 data tables 118 of FIG. 1, a storage group may include a grouping of differing classes of data that is physically stored in separate storage spaces. The administrative tables 120 track the defined storage group data tables 118 and views. A sample administrative table 400 is shown in FIG. 4.

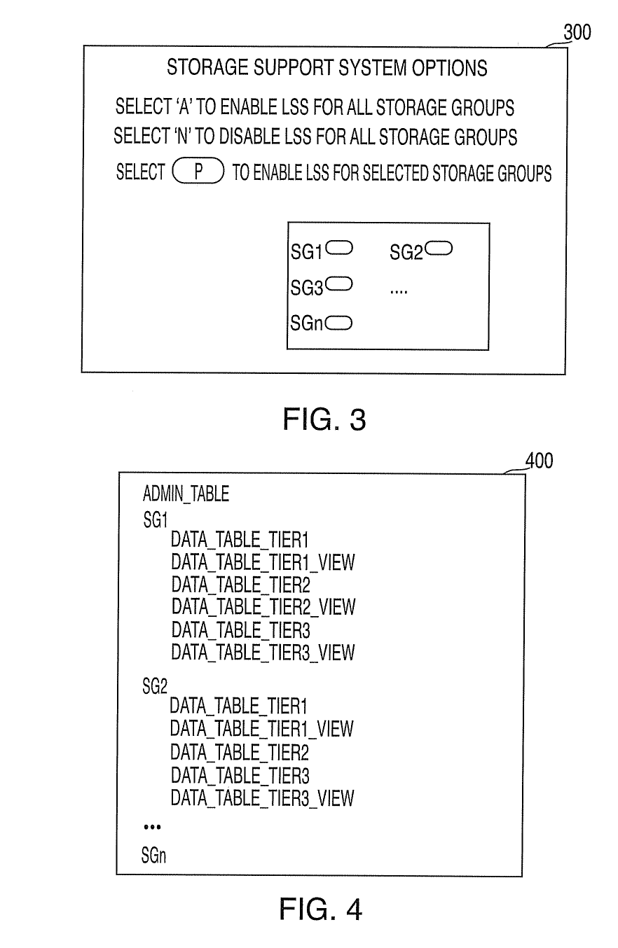

The database management system 112 manages data and runs operations on data based upon requests from applications (e.g., applications 108). The storage support system 110 provides a user interface that enables users to control the location in which data objects are stored. A sample user interface screen 300 is shown and described in FIG. 3. The storage support system 110 may include a component that utilizes database management system 112 to store object data (e.g., directing the data into the database management system 112 for storage). These features are described further herein. The database management system 112 receives database requests from the clients (e.g., applications 108) and performs data access operations to store and retrieve referenced data values from the storage device 114.

Workstation 104 may be a host-attached terminal that requests applications and data from host system 102. As shown in FIG. 1, workstation 104 may execute client-side applications 108 as will be generally understood by those skilled in the art.

Communication link 106 may be a communication network or may be a direct physical link between the workstation 104 and the host system 102 (e.g., cabling). If the link 106 is a network, it may be implemented using any type of known network including, but not limited to, a wide area network (WAN), a local area network (LAN), a global network (e.g. Internet), a virtual private network (VPN), and an intranet. The network may be implemented using a wireless network or any kind of physical network implementation known in the art.

According to the present invention, the storage support system 110 provides binary large object storage subsystem (LSS) support based on three LSS enablement parameters: LSS=N for NONE; LSS=A for ALL; and LSS=P for PARTIAL. This feature is implemented via a user-selectable option referred to herein as an LSS-enablement indicator. If the LSS-enablement indicator=N (as selected by a user), then the storage support system 110 does not enable LSS support for any of the storage groups utilized by the storage system. This may be a default setting. If the LSS-enablement indicator=A, the storage support system 110 enables LSS support for all data object storage groups. If the LSS-enablement indicator=P, the storage support system 110 enables LSS support for a subset of object storage groups. When the LSS-enablement indicator=P, a dynamic mechanism is used by storage support system 110 to determine which object storage groups are to be enabled for LSS support.

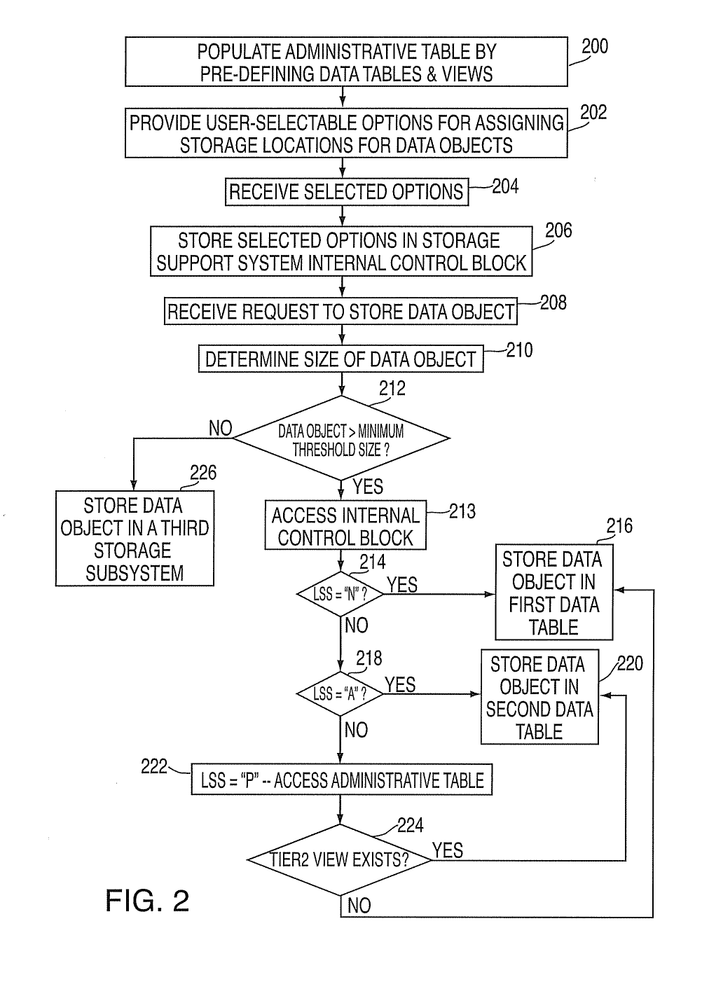

Turning now to FIG. 2, a flow diagram describing a process for implementing the storage support system services will now be described. The process begins at step 200 whereby the system user predefines the data tables and views for each storage group. The DBMS 112 creates an entry in the administration table 120 for each data table and view defined in step 200. At step 202, the storage support system 110 provides a user (e.g., a user of workstation 104) with a user interface that includes selectable options for specifying storage locations for data objects. A sample user interface screen 300 is shown in FIG. 3. As shown in the user interface screen 300, a user may select from options “A”, “N”, and “P” via the LSS-enablement indicator feature.

At step 204, the storage support system 110 receives the user selections. The selected options are stored in the internal control block 122 within the storage support system 110 at step 206.

At step 208, the storage support system 110 receives a request to store a data object that is assigned to a particular storage group. The storage support system 110 determines the size of the data object at step 210 to see if it meets the minimum threshold requirement at step 212. If so, the storage support system 110 accesses the internal control block 122 to ascertain the LSS-enablement indicator selection at step 213. At step 214, the storage support system 110 determines whether the LSS has been disabled for all storage groups via the user-selected options (i.e., user selected “N”) of the LSS-enablement indicator at step 214. If the LSS-enablement indicator reflects that LSS has been disabled for all storage groups, the data object is stored in a data table (e.g., 32K) of a first storage subsystem of a storage group to which the data object is assigned. The first storage subsystem reflects a first tier of storage.

If, however, the LSS has not been disabled for all storage groups (via the LSS-enablement indicator selection) at step 214, it is then determined whether the LSS has been enabled for all storage groups via the LSS-enablement indicator selection at step 218 (i.e., user selected “A” from screen 300 of FIG. 3). If the LSS has been enabled for all storage groups, the data object is stored in a data table (e.g., LSS table) of a second storage subsystem for a storage group to which the data object is assigned at step 220. This second storage subsystem represents a second tier of storage.

If the LSS is neither enabled nor disabled for all storage groups (steps 214 and 218), this means that the user has selected option “P” (i.e., enabled LSS storage for selected storage groups via the LSS-enablement indicator). The storage support system 110 accesses the administrative tables 120 to determine whether a view exists for the data table of the second storage subsystem for the assigned storage group at step 222. A sample administrative table 400 is shown in FIG. 4. The administrative table 400 of FIG. 4 includes entries created for data tables assigned to a particular storage group (e.g., SG1, SG2, . . . SGn). Each data table (e.g., DATA_TABLE_TIER1, DATA_TABLE_TIER2, and DATA_TABLE_TIER3) may each represent a subsystem storage that manages data objects of varying sizes (e.g., 4K, 32K, and >32K). Thus, a set of data tables is assigned to each storage group. By way of example, the administrative table 400 shows that a view exists for the first, second, and third storage subsystems of SG1, while a view exists only for a first and third storage subsystems of SG2.

At step 224, the data object is stored in the data table corresponding to the information contained in the administrative table. Using the information provided in the administrative table 400 as an example, if the data object is assigned to SG1, it will be stored in the data table of the second storage subsystem (i.e., DATA_TABLE_TIER2) because a view exists for the second storage subsystem (i.e., DATA_TABLE_TIER2_VIEW). However, if the data object is assigned to SG2, it will be stored in the data table of the first storage subsystem (i.e., DATA_TABLE_TIER1) because no view exists for the second storage subsystem. It should be noted that the user has the option to add or drop data table views at any time which provides the capability to dynamically enable or disable storing into a given storage subsystem (i.e., DATA_TABLE_TIER2).

Returning to step 212, if the data object meets or does not exceed the minimum threshold value (e.g., 32K(), then the data object is stored in a third data table of an assigned storage group at step 226.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method of determining storage locations for data objects, comprising:
providing user-selectable options for assigning storage locations for data objects, the assigning based upon a minimum threshold size of the data objects that are each defined for a storage group, the user-selectable options implemented via a binary large object storage structure (LSS)-enablement indicator, the storage locations further defined by a view associated with selected storage groups within an administrative table that tracks data tables and views for corresponding storage groups;
storing selected options in an internal control block of a storage support system; and
upon receiving a request to store a data object that exceeds the minimum threshold size:
retrieving the selected options from the LSS-enablement indicator of the internal control block;
if the selected options reflect that the LSS-enablement indicator is disabled for all of the storage groups, storing the data object in a data table of a first storage subsystem for a storage group to which the data object is assigned;
if the selected options reflect that the LSS-enablement indicator is enabled for all of the storage groups, storing the data object in a data table of a second storage subsystem for a storage group to which the data object is assigned; and
if the selected options reflect that the LSS-enablement indicator is enabled for a portion of the storage groups:
accessing the administrative table and determining whether a view for the data table of the second storage subsystem for the assigned storage group exists;
if the view exists, storing the data object in the data table of the second storage subsystem for the assigned storage group; and
if the view does not exist, storing the data object in the data table of the first storage subsystem for the assigned storage group;
wherein the storage groups include a logical grouping of the data objects.

2. The method of claim 1, further comprising storing data objects that meet or do not exceed the minimum threshold size in a data table of a third storage subsystem for a storage group to which the data object is assigned.

3. The method of claim 2, wherein the first and second storage subsystems are binary large object storage subsystems.

4. The method of claim 2, wherein the third storage subsystem is a 4K data table.

5. The method of claim 1, wherein the first storage subsystem is a 32K data table and the minimum threshold size is 32K.

6. The method of claim 1, wherein the second storage subsystem is a binary large object storage structure (LSS) and the minimum threshold size is 32K.

7. A system of determining storage locations for data objects, comprising:
a host system;
a storage support system executing on the host system, the storage support system implementing a method, comprising:
providing user-selectable options for assigning storage locations for data objects, the assigning based upon a minimum threshold size of the data objects that are each defined for a storage group, the user-selectable options implemented via a binary large object storage structure (LSS)-enablement indicator, the storage locations further defined by a view associated with selected storage groups within an administrative table that tracks data tables and views for corresponding storage groups;
storing selected options in an internal control block of the storage support system; and
upon receiving a request to store a data object that exceeds the minimum threshold size:
retrieving the selected options from the LSS-enablement indicator of the internal control block;
if the selected options reflect that the LSS-enablement indicator is disabled for all of the storage groups, storing the data object in a data table of a first storage subsystem for a storage group to which the data object is assigned;
if the selected options reflect that the LSS-enablement indicator is enabled for all of the storage groups, storing the data object in a data table of a second storage subsystem for a storage group to which the data object is assigned; and
if the selected options reflect that the LSS-enablement indicator is enabled for a portion of the storage groups:
accessing the administrative table and determining whether a view for the data table of the second storage subsystem for the assigned storage group exists;
if the view exists, storing the data object in the data table of the second storage subsystem for the assigned storage group; and
if the view does not exist, storing the data object in the data table of the first storage subsystem for the assigned storage group;
wherein the storage groups include a logical grouping of the data objects.

8. The system of claim 7, wherein the storage support system further performs:
storing data objects that meet or do not exceed the minimum threshold size in a data table of a third storage subsystem of a storage group to which the data object is assigned.

9. The system of claim 8, wherein the first and second storage subsystems are binary large object storage subsystems.

10. The system of claim 8, wherein the third storage subsystem is a 4K data table.

11. The system of claim 7, wherein the first storage subsystem is a 32K data table and the minimum threshold size is 32K.

12. The system of claim 1, wherein the second storage subsystem is a binary large object storage structure (LSS) and the minimum threshold size is 32K.

13. A computer program product for determining data storage locations for data objects, the computer program product including instructions for implementing a method, comprising:
providing user-selectable options for assigning storage locations for data objects, the assigning based upon a minimum threshold size of the data objects that are each defined for a storage group, the user-selectable options implemented via a binary large object storage structure (LSS)-enablement indicator, the storage locations further defined by a view associated with selected storage groups within an administrative table that tracks data tables and views for corresponding storage groups;
storing selected options in an internal control block of a storage support system; and
upon receiving a request to store a data object that exceeds the minimum threshold size:
retrieving the selected options from the LSS-enablement indicator of the internal control block;
if the selected options reflect that the LSS-enablement indicator is disabled for all of the storage groups, storing the data object in a data table of a first storage subsystem for a storage group to which the data object is assigned;
if the selected options reflect that the LSS-enablement indicator is enabled for all of the storage groups, storing the data object in a data table of a second storage subsystem for a storage group to which the data object is assigned; and
if the selected options reflect that the LSS-enablement indicator is enabled for a portion of the storage groups:
accessing the administrative table and determining whether a view for the data table of the second storage subsystem for the assigned storage group exists;
if the view exists, storing the data object in the data table of the second storage subsystem for the assigned storage group; and
if the view does not exist, storing the data object in the data table of the first storage subsystem for the assigned storage group;
wherein the storage groups include a logical grouping of the data objects.

14. The computer program product of claim 13, further comprising instructions for storing data objects that meet or do not exceed the minimum threshold size in a data table of a third storage subsystem for a storage group to which the data object is assigned.

15. The computer program product of claim 14, wherein the first and second storage subsystems are binary large object storage subsystems.

16. The computer program product of claim 14, wherein the third storage subsystem is a 4K data table.

17. The computer program product of claim 13, wherein the first storage subsystem is a 32K data table and the minimum threshold size is 32K.

18. The computer program product of claim 13, wherein the second storage subsystem is a binary large object storage structure (LSS) and the minimum threshold size is 32K.
